(19) United States
(12) Patent Application Publication
(10) Pub. No.: US 2024/0247101 A1
(43) Pub. Date: Jul. 25, 2024

(54) POLYESTER RESIN AND METHOD FOR USING SAME, COSMETIC CONTAINER, AND COSMETIC PRODUCT

(71) Applicants: Bell Polyester Products, Inc., Yamaguchi (JP); DAIWA CAN COMPANY, Tokyo (JP)

(72) Inventors: Takaaki IKEDA, Yamaguchi (JP); Yusuke ITO, Yamaguchi (JP); Akane NOZAKI, Yamaguchi (JP)

(21) Appl. No.: 18/560,173

(22) PCT Filed: May 2, 2022
(86) PCT No.: PCT/JP2022/019506

§ 371 Date: Nov. 10, 2023

(30) Foreign Application Priority Data
May 11, 2021 (JP) 2021-080464

(51) Int. Cl. C08G 63/183; A45D 34/00; A45D 40/00; B65D 65/38; C08G 63/672

(52) U.S. Cl. CPC C08G 63/183; B65D 65/38; C08G 63/672; A45D 34/00; A45D 40/00

(57) ABSTRACT

Polyester resin includes polymer of acid component (A) and alcohol component (B). Component (A) contains 72 mol % or more of terephthalic acid component (A1) and from 8 to 28 mol % of isophthalic acid component (A2) with respect to total amount of component (A). Component (B) contains 77 mol % or more of ethylene glycol component (B1) and from 4 to 18 mol % of 2,2-dimethyl-1,3-propanediol component (B2) with respect to total amount of component (B). Sum of content by percentage of component (A2) with respect to component (A) and content by percentage of component (B2) with respect to component (B) is from 24 to 43 mol %. Content of diethylene glycol component (B3) with respect to total amount of component (B) is 5 mol % or less. Polyester resin has intrinsic viscosity of from 0.48 to 0.67 dl/g.

### CROSS REFERENCE TO RELATED APPLICATIONS

The present invention is based upon and claims the benefit of the priority of Japanese Patent Application No. 2021-80464 (filed on May 11, 2021), the entire of which is incorporated herein in its entirety by reference.

### TECHNICAL FIELD

The present disclosure relates to a polyester resin and a method for using the same. The present disclosure also relates to a cosmetic container including the polyester resin, and a cosmetic product using the cosmetic container.

### BACKGROUND ART

Polyethylene terephthalate (PET) obtained by copolymerizing terephthalic acid and ethylene glycol is used for various applications. A polyester resin having polyethylene terephthalate as a main structure, with neopentyl glycol partially copolymerized thereto as an alcohol component, is known in the art (see, for example, Patent Literatures 1 and 2).

The copolymerized polyester resin disclosed in Patent Literature 1 contains 100 mol % of terephthalic acid as a dicarboxylic acid component, and 79 to 94.5 mol % of ethylene glycol, 3.0 to 20.0 mol % of neopentyl glycol and 1.0 to 2.5 mol % of diethylene glycol as glycol components, and has an intrinsic viscosity of 0.77 to 0.78 dl/g. The copolymerized polyester resin disclosed in Patent Literature 2 contains 100 mol % of terephthalic acid as a dicarboxylic acid component, and 79 to 94.5 mol % of ethylene glycol, 4.0 to 31.2 mol % of neopentyl glycol and 1.9 to 2.8 mol % of diethylene glycol as glycol components, and has an intrinsic viscosity of 0.71 to 0.75 dl/g.

### CITATION LIST

### Patent Literature

Patent Literature 1: Japanese Unexamined Patent Publication No. 2011-68879A

Patent Literature 2: Japanese Unexamined Patent Publication No. 2004-123984A

### SUMMARY OF INVENTION

### Technical Problem

The following analysis can be made from the perspective of the present disclosure.

In cases of using a resin as a material for a container, the resin is selected depending on the content and the purpose of use. For example, a resin having high resistance against its contents may be selected in order to prevent the container from discoloring or degrading due to contact with the content (the object contained). In cases where it is desired to improve the container's aesthetic properties or increase the visibility of the content, a highly transparent resin may be selected, rather than an opaque resin. In cases where it is desired to improve designability, a resin having good moldability may be selected so that the resin can be easily molded into intricate shapes.

In general, however, the resin's resistance against contents (object in contact) containing an organic compound tends to deteriorate when attempts are made to improve the resin's transparency or moldability. There has, therefore, been a demand for resins with improved resistance against contents, as well as moldability and transparency, in order to obtain a container that can contain desired contents and that is also usable for desired applications.

Increasing the intrinsic viscosity as with the copolymerized polyester resins disclosed in Patent Literatures 1 and 2 will in turn raise the molding temperature, i.e., the temperature for achieving a melt viscosity suitable for molding. A rise in molding temperature will make the polyester resin more susceptible to degradation, and also, production efficiency will deteriorate. Further, the copolymerized polyester resins disclosed in Patent Literatures 1 and 2 have a high structural ratio of PET; thus, crystalline portions are likely to be produced, and also, forming a thick-walled portion will cause that portion to become cloudy. Furthermore, it is difficult to improve moldability, transparency, and resistance against objects in contact simply by adjusting alcohol components, as in the copolymerized polyester resins disclosed in Patent Literatures 1 and 2.

Therefore, there is a demand for a polyester resin that has excellent moldability, is moldable at low temperatures, has improved resistance against objects in contact, and from which a transparent molded product can be obtained.

Further, there is a demand for a cosmetic container and a cosmetic product using such a polyester resin.

### Solution to Problem

According to a first aspect of the present disclosure, a polyester resin including a polymer of an acid component (A) and an alcohol component (B) is provided. The component (A) contains 72 mol % or more of a terephthalic acid component (A1) and from 8 to 28 mol % of an isophthalic acid component (A2) with respect to a total amount of the component (A). The component (B) contains 77 mol % or more of an ethylene glycol component (B1) and from 4 to 18 mol % of a 2,2-dimethyl-1,3-propanediol component (B2) with respect to a total amount of the component (B). A sum of a content by percentage of the component (A2) with respect to the component (A) and a content by percentage of the component (B2) with respect to the component (B) is from 24 to 43 mol %. A content of a diethylene glycol component (B3) with respect to the total amount of the component (B) is 5 mol % or less. The polyester resin has an intrinsic viscosity of from 0.48 to 0.67 dl/g.

According to a second aspect of the present disclosure, a cosmetic container including the polyester resin according to the first aspect is provided.

According to a third aspect of the present disclosure, a cosmetic product is provided, the cosmetic product including a cosmetic, and the cosmetic container according to the second aspect, containing the cosmetic.

According to a fourth aspect of the present disclosure, a method for using the polyester resin is provided, the method comprising using the polyester resin according to the first aspect for a cosmetic container.

### Advantageous Effects of Invention

The polyester resin of the present disclosure has excellent moldability.

The polyester resin of the present disclosure is moldable at low temperatures.

The polyester resin of the present disclosure has high transparency as a molded product.

The polyester resin of the present disclosure has high resistance against objects in contact.

By using the polyester resin of the present disclosure for a cosmetic container, it is possible to provide a cosmetic container and a cosmetic product having excellent safety, visibility, and aesthetic properties.

### BRIEF DESCRIPTION OF DRAWINGS

FIG. 1 is a schematic diagram for illustrating a stress cracking test.

### DESCRIPTION OF EMBODIMENTS

According to a preferred mode of the above first aspect, the sum of a content by percentage of the component (A2) with respect to the component (A) and a content by percentage of the component (B2) with respect to the component (B) is from 27 to 40 mol %.

According to a preferred mode of the above first aspect, the polyester resin has a melt viscosity of from 100 to 200 Pas at 180° C.

According to a preferred mode of the above first aspect, the polyester resin has a tensile elongation of 100% or greater.

According to a preferred mode of the above first aspect, the polyester resin has a Charpy impact strength of 2 KJ/m² or greater.

According to a preferred mode of the above first aspect, the polyester resin has a container shape.

According to a preferred mode of the above first aspect, the polyester resin is used for a cosmetic container.

In the following description, reference signs in the drawing are provided for the understanding of the invention and are not intended to limit the invention to the aspects shown. The drawing is not intended to limit the invention to illustrated aspects, such as illustrated shapes, dimensions, and scales. In each embodiment, the same components are accompanied by the same reference signs.

Polyester resins of the present disclosure (including molded products thereof) will be described. In the present disclosure, “polyester resin” may encompass “molded product” unless specifically stated otherwise. The polyester resin of the present disclosure is a polyester resin which is a copolymer of an acid component (a polycarboxylic acid) and an alcohol component (a polyol or a polyhydroxy compound). In the present disclosure, “polycarboxylic acid” refers to a compound having a plurality of carboxy groups. “Polyol” or “polyhydroxy compound” refers to a compound having a plurality of hydroxy groups.

The acid component mainly contains a terephthalic acid component. The content by percentage of the terephthalic acid component is preferably 72 mol % or more, more preferably 75 mol % or more, with respect to the total amount of the acid component. The content by percentage of the terephthalic acid component may be, for example, 77 mol % or more, 80 mol % or more, 82 mol % or more, 83 mol % or more, 84 mol % or more, or 86 mol % or more, with respect to the total amount of the acid component. If the content of the terephthalic acid component is less than 72 mol %, the physical strength of the polyester resin may deteriorate. The content by percentage of the terephthalic acid component is preferably 92 mol % or less, more preferably 90 mol % or less, further preferably 88 mol % or less, with respect to the total amount of the acid component. The content by percentage of the terephthalic acid component may be, for example, 86 mol % or less, 85 mol % or less, 84 mol % or less, 82 mol % or less, 80 mol % or less, 79 mol % or less, or 77 mol % or less, with respect to the total amount of the acid component. If the content of the terephthalic acid component exceeds 92 mol %, melt viscosity may become too high.

The acid component further contains an isophthalic acid component. The content by percentage of the isophthalic acid component is preferably 8 mol % or more, more preferably 10 mol % or more, with respect to the total amount of the acid component. The content by percentage of the isophthalic acid component may be, for example, 12 mol % or more, 14 mol % or more, 15 mol % or more, 16 mol % or more, 18 mol % or more, 20 mol % or more, 21 mol % or more, or 23 mol % or more, with respect to the total amount of the acid component. If the content of the isophthalic acid component is less than 8 mol %, molding at low temperature may become difficult, and also the molded product's transparency may deteriorate. The content by percentage of the isophthalic acid component is preferably 28 mol % or less, more preferably 25 mol % or less, with respect to the total amount of the acid component. The content by percentage of the isophthalic acid component may be, for example, 23 mol % or less, 20 mol % or less, 18 mol % or less, 17 mol % or less, 16 mol % or less, or 14 mol % or less, with respect to the total amount of the acid component. If the content of the isophthalic acid component exceeds 28 mol %, mechanical strength may deteriorate.

The sum total of the terephthalic acid component and the isophthalic acid component is preferably 90 mol % or more, more preferably 95 mol % or more, with respect to the total amount of the acid component. The sum total of terephthalic acid and isophthalic acid may be 100 mol % with respect to the total amount of the acid component.

The acid component may contain other acid components insofar as the inherent properties of the polyester resin of the present disclosure are not changed. Examples of other acid components may include orthophthalic acid, 2,6-naphthalenedicarboxylic acid, adipic acid, sebacic acid, succinic acid, dimer acid, 1,4-cyclohexadicarboxylic acid, dimethyl terephthalate, dimethyl isophthalate, trimellitic acid, and derivatives thereof. One of the aforementioned other acid component may be included singly, or two or more types may be included in arbitrary proportions.

The alcohol component mainly contains an ethylene glycol component. The content by percentage of the ethylene glycol component is preferably 77 mol % or more, more preferably 81 mol % or more, with respect to the total amount of the alcohol component. The content by percentage of the ethylene glycol component may be, for example, 82 mol % or more, 84 mol % or more, 85 mol % or more, 86 mol % or more, 87 mol % or more, 88 mol % or more, or 90 mol % or more, with respect to the total amount of the alcohol component. If the content of the ethylene glycol component is less than 77 mol %, resistance against objects in contact may deteriorate. The content by percentage of the ethylene glycol component is preferably 96 mol % or less, more preferably 92 mol % or less, with respect to the total amount of the alcohol component. The content by percentage of the ethylene glycol component may be, for example, 90 mol % or less, 88 mol % or less, 86 mol % or less, or 84 mol % or less, with respect to the total amount of the alcohol component. If the content of the ethylene glycol component exceeds 96 mol %, melt viscosity may become too high.

The alcohol component further contains a 2,2-dimethyl-1,3-propanediol component (also referred to hereinafter as “neopentyl glycol component”). The content by percentage of the neopentyl glycol component is preferably 4 mol % or more with respect to the total amount of the alcohol component. The content by percentage of the neopentyl glycol component may be, for example, 6 mol % or more, 8 mol % or more, 10 mol % or more, or 12 mol % or more, with respect to the total amount of the alcohol component. If the content of the neopentyl glycol component is less than 4 mol %, the mechanical strength of the polyester resin may tend to deteriorate. The content by percentage of the neopentyl glycol component is preferably 18 mol % or less, more preferably 16 mol % or less, with respect to the total amount of the alcohol component. The content by percentage of the neopentyl glycol component may be, for example, 15 mol % or less, 14 mol % or less, 13 mol % or less, 12 mol % or less, or 10 mol % or less, with respect to the total amount of the alcohol component. If the content of the neopentyl glycol component exceeds 18 mol %, the resistance of the polyester resin against objects in contact may deteriorate.

The sum total of the ethylene glycol component and the neopentyl glycol component is preferably 90 mol % or more, more preferably 95 mol % or more, with respect to the total amount of the alcohol component. The sum total of the ethylene glycol component and the neopentyl glycol component may be 100 mol % with respect to the total amount of the alcohol component.

The alcohol component may contain a diethylene glycol component. The diethylene glycol component may be produced as a by-product. The content by percentage of the diethylene glycol component is preferably 5 mol % or less, more preferably 4 mol % or less, further preferably 3 mol % or less, further preferably 2 mol % or less, even more preferably 0 mol %, with respect to the total amount of the alcohol component. If the content of the diethylene glycol component exceeds 5 mol %, the polyester resin's heat resistance and resistance against objects in contact may deteriorate. The sum total of the ethylene glycol component, the neopentyl glycol component, and the diethylene glycol component may be, for example, 95 mol % or more, preferably 100 mol %, with respect to the total amount of the alcohol component.

The alcohol component may contain other alcohol components insofar as the inherent properties of the polyester resin of the present disclosure are not changed. Examples of other alcohol components may include 1,3-propanediol, 2-methyl-1,3-propanediol, 2-butyl-2-ethyl-1,3-propanediol, 1,2-propanediol, 1,4-butanediol, 1,3-butanediol, diethylene glycol, 1,4-cyclohexanediol, 1,4-cyclohexanedimethanol, and derivatives thereof. One type of the aforementioned other alcohol component may be included singly, or two or more types may be included in arbitrary proportions.

It is preferred that the sum total of the content by percentage of the isophthalic acid component, which is based on the total amount of the acid component, and the content by percentage of the neopentyl glycol component, which is based on the total amount of the alcohol component, is 24 mol % or more. The sum total may be, for example, 26 mol % or more, 30 mol % or more, or 35 mol % or more. If the sum total is less than 24 mol %, melt viscosity may become high, and transparency may deteriorate. The sum total is preferably 43 mol % or less. The sum total may be, for example, 40 mol % or less, 38 mol % or less, or 35 mol % or less. If the sum total exceeds 43 mol %, resistance against objects in contact may deteriorate.

The polyester resin of the present disclosure has an intrinsic viscosity (IV value) of preferably 0.48 dl/g (102 cm³/g) or greater, more preferably 0.50 dl/g or greater. The intrinsic viscosity of the polyester resin of the present disclosure may be, for example, 0.52 dl/g or greater, 0.55 dl/g or greater, or 0.58 dl/g or greater. If the intrinsic viscosity is less than 0.48 dl/g, it may not be possible to obtain sufficient mechanical properties. The intrinsic viscosity (IV value) of the composition of the present disclosure is preferably 0.67 dl/g or less, more preferably 0.65 dl/g or less. The intrinsic viscosity of the polyester resin of the present disclosure may be, for example, 0.62 dl/g or less, 0.60 dl/g or less, or 0.58 dl/g or less. If the intrinsic viscosity exceeds 0.67 dl/g, melt viscosity may become high. In cases where the melt viscosity is high, it is necessary to raise the heating temperature and lower the melt viscosity. This may result in an increase in cooling time and degradation in productivity, as well as degradation of the polyester resin. On the other hand, if molding is forcibly attempted while the melt viscosity is still high, without raising the heating temperature, then the polyester resin may not flow into the mold successfully, resulting in molding failure, or the polyester resin may cause shear heating, leading to degradation of the polyester resin.

The intrinsic viscosity is defined as the intrinsic viscosity at 20° C. found through measurement with an automatic viscosity measurement device equipped with an Ubbelohde viscometer by dissolving 0.5000±0.0005 g of a sample into a mixed solvent containing phenol and tetrachloroethane at a ratio of 60:40 (mass ratio).

The melt viscosity, at 180° C., of the polyester resin of the present disclosure is preferably 100 Pa·s or greater, more preferably 110 Pa·s or greater. The melt viscosity, at 180° C., of the polyester resin of the present disclosure may be, for example, 120 Pas or greater, 130 Pa·s or greater, or 140 Pa·s or greater. If the melt viscosity is below 100 Pas, it may not be possible to obtain sufficient mechanical properties. The melt viscosity, at 180° C., of the composition of the present disclosure is more preferably 200 Pa·s or less, even more preferably 190 Pa·s or less. The melt viscosity, at 180° C., of the polyester resin of the present disclosure may be, for example, 180 Pa·s or less, 170 Pas or less, or 160 Pa·s or less. If the melt viscosity exceeds 200 Pa·s, the same issues may arise as when the intrinsic viscosity is high.

The “melt viscosity at 180° C.” is the melt viscosity measured for 20.0±5.0 g of each dried polyester resin using a melt viscosity measurement device at a measurement temperature of 180° C. and shear rate of 6080 see-1. The method for drying the polyester resin is not particularly limited; for example, the polyester resin can be dried using a dehumidification dryer under conditions of 60° C. for 48 hours.

The tensile elongation of the polyester resin of the present disclosure is preferably 160% or greater, more preferably 180% or greater. If the tensile elongation is less than 160%, it may not be possible to obtain sufficient mechanical properties. The tensile elongation can be measured in conformity with ISO 527.

It is preferred that the polyester resin of the present disclosure has a Charpy impact strength of 2 KJ/m² or greater. The Charpy impact strength of the polyester resin of the present disclosure may be, for example, 2.1 kJ/m² or greater, or 2.2 kJ/m² or greater. If the Charpy impact strength is less than 2 KJ/m², it may not be possible to obtain sufficient mechanical properties. Charpy impact strength can be measured in conformity with ISO 179.

It is preferred that the polyester resin of the present disclosure has a glass transition temperature of preferably 65° C. or higher, more preferably 70° C. or higher. The glass transition temperature can be measured, for example, by using a differential scanning calorimetry (DSC) device.

It is preferred that, when the polyester resin of the present disclosure is subjected to DSC measurement from 40° ° C. to 270° C. at a temperature rise rate of 10° C./minute, no peak in melting point is observed.

The polyester resin of the present disclosure may further contain a polymerization catalyst. Examples of the polymerization catalyst may include germanium compounds, titanium compounds, etc.

The polyester resin of the present disclosure may contain known additives, such as antistatic agents, UV absorbers, thermal stabilizers, mold-release agents, antioxidants, etc., insofar as the inherent properties of the composition of the present disclosure are not changed.

For example, the polyester resin of the present disclosure may further contain a phosphorus-containing compound. Examples of the phosphorus-containing compound may include phosphoric acid, phosphorous acid, trimethyl phosphate, triethyl phosphate, tributyl phosphate, trimethyl phosphite, triethyl phosphite, tributyl phosphite, etc. Among the above, trimethyl phosphate is particularly preferable. The content of the phosphorus-containing compound may preferably be from 5 to 1000 ppm, more preferably from 20 to 100 ppm, with respect to the mass of the polyester resin.

The polyester resin of the present disclosure may encompass polyester resins obtained through production methods described below. As regards features of the polyester resin of the present disclosure other than those described above, there are cases where it is difficult, or utterly impractical, to directly define the structure etc. of the polyester resin based on its compositional makeup etc. In such circumstances, it should be permissible to define the polyester resin of the present disclosure according to methods for producing the same.

The polyester resin of the present disclosure is usable for a wide variety of molding materials, for example, for containers, electric/electronic components, automotive materials, etc.

With the polyester resin of the present disclosure, the molding temperature can be lowered. For example, the molding temperature may be from 170° C. to 220° C., preferably from 180° C. to 200° C. In this way, the amount of energy required for molding can be reduced. Also, particularly, the time for cooling can be shortened, and thus, production efficiency can be improved. As a result, molding cost can be reduced.

Further, by keeping the molding temperature low, it is possible to inhibit decomposition of the polyester resin in its molten state. As a result, it is possible to inhibit degradation in quality of molded products. Further, by keeping the intrinsic viscosity low, it is possible to inhibit unevenness in temperature caused by shear heating in a molten state. As a result, it is possible to make the quality of molded products uniform.

Further, by keeping the molding temperature low, the mold cooling temperature can be raised. As a result, costs related to energy required for cooling can be reduced. Also, condensation can be inhibited from forming on the mold.

The polyester resin of the present disclosure has high transparency even when molded. For example, clouding can be inhibited even when molded into a thick-walled container. As a result, molded products made from the polyester resin of the present disclosure can achieve excellent appearance. Also, the polyester resin of the present disclosure can improve the diversity in design of molded products.

The polyester resin of the present disclosure has high moldability. For example, the polyester resin of the present disclosure can easily be charged into a mold in injection molding, thereby inhibiting the occurrence of short shots. As a result, with the polyester resin of the present disclosure, it is possible to produce molded products having intricate shapes.

The polyester resin of the present disclosure has high resistance against objects in contact, such as organic compounds etc., while having excellent moldability as well as low-temperature moldability and transparency. For example, even when the polyester resin comes into contact with a product containing an organic compound, discoloring and degradation of the polyester resin can be inhibited. Therefore, the polyester resin of the present disclosure can be used, for example, as a container for cosmetics.

The polyester resin of the present disclosure can suitably be used as a container body for housing cosmetics. The polyester resin of the present disclosure can also be suitably used as a lid detachably attachable to the container body. A cosmetic container may contain, for example, 70 mass % or greater, 80 mass % or greater, 90 mass % or greater, or 95 mass % or greater, of the polyester resin of the present disclosure with respect to the mass of the container. The entirety (100 mass %) of the cosmetic container can be constituted by the polyester resin of the present disclosure. The polyester resin of the present disclosure has high transparency, and therefore, by making the container body out of the polyester resin of the present disclosure, the contents (cosmetics) can be made visible from outside.

The polyester resin of the present disclosure has sufficient mechanical properties.

Methods for producing the polyester resin of the present disclosure will be described.

The polyester resin of the present disclosure can be produced according to a known method using the aforementioned monomers and additives. For example, an ester prepolymer may be produced by direct esterification using an unsubstituted polycarboxylic acid as a starting material, or an ester prepolymer may be produced by a transesterification reaction using an esterified product, such as a dimethyl ester etc., as a starting material. From the viewpoint of production efficiency, it is preferred to select a direct esterification reaction.

The rate of addition of monomers and additives may be the rate described in the explanation above regarding the polyester resin of the present disclosure.

The direct esterification reaction or transesterification reaction can be conducted, for example, by: placing the materials in a reaction vessel equipped with a heater, a stirrer and a distillation tube; adding a reaction catalyst thereto and raising the temperature while stirring the materials under atmospheric pressure in an inert gas atmosphere; and causing the reaction to progress while removing, by distillation, by-products produced by the reaction, such as methanol etc. The reaction temperature may be, for example, from 150° C. to 270° C., preferably from 160° C. to 260° C. The reaction time may be, for example, approximately from 3 to 7 hours.

As for the catalyst for the transesterification reaction, it is possible to use at least one type of metal compound. Preferred examples of metal elements may include sodium, potassium, calcium, titanium, lithium, magnesium, manganese, zinc, tin, cobalt, etc. Among the above, titanium compounds and manganese compounds are preferable because they have high reactivity and can offer a favorable color tone to the obtained resin. The amount of transesterification catalyst to be added may typically be preferably from 5 to 1000 ppm, more preferably from 10 to 100 ppm, with respect to the polyester resin to be produced.

In order to inhibit the production of the diethylene glycol component, which is a by-product, it is preferred to reduce the amount of ethylene glycol in the reaction system. For example, the molar ratio between the alcohol component content and the acid component content (ratio of the alcohol component to the acid component) is preferably 1.3 or less. Also, it is possible to inhibit the production of diethylene glycol by adding, for example, 5 ppm of sodium hydroxide.

After termination of the direct esterification reaction or transesterification reaction, it is preferred to add a phosphorus-containing compound to further promote the esterification reaction. Examples of the phosphorus-containing compound may include phosphoric acid, phosphorous acid, trimethyl phosphate, triethyl phosphate, tributyl phosphate, trimethyl phosphite, triethyl phosphite, tributyl phosphite, etc. Among the above, trimethyl phosphate is particularly preferable. The amount of use of the phosphorus-containing compound may preferably be from 5 to 1000 ppm, more preferably from 20 to 100 ppm, with respect to the mass of the polyester resin to be produced.

Among the polyol components in the present disclosure, neopentyl glycol may be added in the course of a direct esterification reaction between a polycarboxylic acid component and ethylene glycol, or may be added after termination of the esterification reaction. It is preferred to first prepare a slurry by mixing, in advance, a polycarboxylic acid component together with ethylene glycol and neopentyl glycol at atmospheric temperature, and then cause an esterification reaction to progress in an esterification reaction vessel, because in this way, scattering of neopentyl glycol can be inhibited. Further, in the present disclosure, the whole quantity of ethylene glycol can be added before the esterification reaction, and portions thereof do not have to be added after the esterification reaction.

Following the transesterification reaction and esterification reaction, a polymerization catalyst may be added to the ester prepolymer to further cause a polycondensation reaction until a desired molecular weight is achieved. An example of a catalyst usable for the polymerization reaction may be germanium dioxide. The rate of addition of the catalyst may be from 180 to 220 ppm with respect to the amount of resin to be produced. The polycondensation reaction can be conducted, for example, by first adding a polymerization catalyst, and then gradually raising the temperature inside the reaction vessel while reducing the pressure. It is preferred to reduce the pressure inside the vessel to, for example, a final pressure of 0.4 kPa or lower, preferably 0.2 kPa or lower. It is preferred to raise the temperature inside the vessel to, for example, a final temperature of preferably 250° ° C. to 290° C. The polymerization reaction can be conducted, for example, until a predetermined melt viscosity is reached under reduced pressure where the final inner-vessel pressure is 150 Pa or lower. Then, the inner pressure of the vessel may be pressurized to, for example, 0.5 MPa, to extrude and collect the reaction product from the bottom of the vessel. For example, the reaction product may be extruded into water in strands and then be cut after being cooled, to obtain pellets of the polyester resin. In the present disclosure, the obtained pellets do not have to be subjected to an infrared irradiation step.

For the polymerization catalyst, it is possible to use a catalyst other than germanium dioxide. For example, titanium dioxide can be used as a polymerization catalyst. In cases of using titanium dioxide, the rate of addition of the catalyst may be, for example, from 1 to 10 ppm with respect to the amount of resin to be produced.

The polyester resin of the present invention may contain, as appropriate, various additives, such as antioxidants, thermal stabilizers, slip additives, antistatic agents, plasticizers, UV absorbers, pigments, etc., depending on the usage and objective of molding. These additives may be blended either during the polymerization reaction step or the processing/molding step. Examples of antioxidants may include hindered phenol-based antioxidants, phosphorus-based antioxidants, sulfur-based antioxidants, etc., with hindered phenol-based antioxidants being particularly preferable. The amount of addition is preferably around 100 to 5000 ppm. In cases of molding a melt-extruded film, a metal salt, such as magnesium acetate, calcium acetate, magnesium chloride, etc., may be added in order to stabilize the cooling rollers' electrostatic pinning properties.

According to these methods for producing the polyester resin of the present disclosure, it is possible to produce a composition having the aforementioned properties.

A method for producing a molded product of the polyester resin of the present disclosure will be described. For the method for producing a molded product of the polyester resin, it is possible to adopt injection molding, for example.

First, the polyester resin of the present disclosure is molten. The temperature of a heating device (e.g., a cylinder) for melting the polyester resin is set to a temperature that does not create non-molten portions of the composition. The setting temperature of the heating device may preferably be 220° C. or lower, more preferably 200° C. or lower, and may be 180° C. or lower for some polyester resins. By lowering the heating temperature, it is possible to shorten the time for cooling, thereby improving production efficiency as well as inhibiting deterioration in quality. The setting temperature of the heating device may be 170° C. or higher, or 180° C. or higher. The polyester resin of the present disclosure has a low intrinsic viscosity, and thus, the temperature of the polyester resin can be inhibited from largely deviating from the setting temperature due to shear heating. Also, it is possible to inhibit unevenness in temperature of the melt.

Second, the molten polyester resin is charged into a mold. The mold can be maintained at a predetermined temperature. The temperature of the mold may be set to, for example, from 20° C. to 60° C., preferably from 30° ° C. to 50° C. If the mold temperature is set below 20° C., and particularly below room temperature, a large amount of energy will be required for cooling. Also, condensation may form on the mold, which may promote mold degradation. It is preferred to cool the mold with water.

Third, the polyester resin charged in the mold is molded by being retained therein for a predetermined time. After molding, the molded product is removed from the mold. The retention time from when the resin is injected into the mold until when it is removed therefrom is considered the cooling time (molding time). The cooling time depends on the size, particularly thickness, of the molded product.

According to the method for producing a molded product of the polyester resin of the present disclosure, it is possible to reduce production costs by reducing energy consumption and improving production efficiency. Also, it is possible to produce molded products having high and uniform quality.

Molded products of the polyester resin of the present disclosure will be described.

A molded product of the polyester resin of the present disclosure is a molded product produced according to the aforementioned production method. For example, the molded product of the polyester resin of the present disclosure may be a molded product produced by melting the polyester resin at a temperature set between 160° C. or higher, preferably 180° C. or higher, and 200° C. or lower, and molding the same. The molded product of the present disclosure preferably has a portion having a thickness of 2 mm or greater, more preferably a portion having a thickness of 3 mm or greater, even more preferably a portion having a thickness of 5 mm or greater. The time for cooling can be shortened more effectively in cases where the molded product has a portion having a thickness of 2 mm or greater. For example, in cases of obtaining a molded product having a thickness of 5 mm, the molded product can be obtained by setting the heating temperature to 180° C. and molding the same in a mold at 20° ° C. to 60° C. for a cooling time of approximately 20 seconds. The thickest portion in the molded product of the present disclosure may have a thickness of 10 mm or less. In cases of obtaining a molded product having a thickness of 10 mm, the molded product can be obtained by setting the heating temperature to 180° C. and molding the same in a mold at 20° ° C. to 60° C. for a cooling time of approximately 75 seconds.

The compositional makeup and properties of the molded product may differ from those of the polyester resin before being molded, depending on the heating/melting conditions at the time of producing the molded product. There are cases where it is difficult to directly define the compositional makeup or properties of the molded product, and in such circumstances, it is useful to define the molded product according to methods for producing the molded product from the polyester resin before being molded.

The molded product of the polyester resin of the present disclosure is molded at a low temperature, and can thus be provided with a quality having undergone little degradation from the polyester resin before molding. Further, the molded product of the polyester resin of the present disclosure is not affected by unevenness in heat generation due to shear heating, and can thus be provided with a uniform quality. The molded product of the polyester resin of the present disclosure can be provided with desired dimensions even in a short cooling time.

The molded product of the polyester resin of the present disclosure can be designed variously. For example, the molded product can be designed into a container having a thick, transparent bottom. Such a container can offer a high-grade look/feel. The molded product can also be designed into a container having an intricate shape.

The molded product of the polyester resin of the present disclosure has high resistance against objects in contact (e.g., organic compounds), undergoing little discoloring and deformation, even while having excellent moldability, low-temperature moldability and transparency.

According to the present disclosure, the polyester resin of the present disclosure can be molded into a cosmetic container for containing cosmetics.

Cosmetic containers and cosmetic products of the present disclosure will be described.

A cosmetic product of the present disclosure includes a cosmetic, and a cosmetic container for containing the cosmetic. The cosmetic container—particularly, the container body for containing the cosmetic—is a cosmetic container including the polyester resin of the present disclosure. It is preferred that the cosmetic container—particularly, the container body for containing the cosmetic—is a molded product of the polyester resin of the present disclosure.

The cosmetic may take any form, such as an aqueous composition, an oily composition, an emulsified composition (oil-in-water composition, water-in-oil composition, etc.), etc. Examples of cosmetics may include sun-block cosmetics, toners, foundations, lipsticks, moisturizers, nail polish, mascaras, hair cosmetics, etc.

By employing the polyester resin of the present disclosure for cosmetic containers, it is possible to provide cosmetic containers and cosmetic products having excellent safety, visibility, and aesthetic properties.

In the present disclosure, the term “or greater (or higher; or more)” may be read as “greater than (higher than; more than)”, as the case may be. Likewise, the term “or less (or lower)” may be read as “less than (lower than)”, as the case may be.

Polyester resins of the present disclosure (including molded products), as well as methods for using the same, cosmetic containers and cosmetic products, will be described below by way of Examples. Note, however, that the polyester resins of the present disclosure, methods for using the same, cosmetic containers, and cosmetic products are not limited to the following Examples.

### EXAMPLES

### Test Examples 1 to 15

Polyester resins were prepared, and for each polyester resin, the intrinsic viscosity, melt viscosity, glass transition temperature, content resistance, and mechanical properties were tested. Tables 1 and 2 show the respective compositional makeup and measurement results for Test Examples 1 to 15.

### {Preparation of Polyester Resin}

According to the respective compositional ratios shown in Tables 1 and 2, terephthalic acid (TPA), isophthalic acid (IPA), ethylene glycol (EG), and 2,2-dimethyl-1,3-propanediol (neopentyl glycol (NPG)) were placed in a 30 L autoclave, and an esterification reaction was conducted at 250° C. in a nitrogen stream under an atmospheric pressure condition. The blending ratios shown in Tables 1 and 2 are ratios shown separately for the acid component and the alcohol component. Next, while using germanium dioxide as a polymerization catalyst, the pressure inside the reaction vessel was reduced over 1 hour, and a polycondensation reaction was conducted at 270° C. under reduced pressure of 100 Pa or lower, until a predetermined viscosity was achieved. The reaction product was extruded from the reaction vessel into water and was cut with a pelletizer, to obtain resin pellets. Each produced polyester resin was subjected to the following measurements.

In Test Example 15, the material ratio G/A between alcohol (G) and acid (A) was set to 1.6, to produce a greater amount of diethylene glycol.

### {Measurement of Intrinsic Viscosity}

For each polyester resin, the intrinsic viscosity at 20° ° C. was measured using an automatic viscosity measurement device (ALC-6C from Sun Electronic Industries Corp.) equipped with an Ubbelohde viscometer by dissolving 0.5000 g+0.0005 g of a sample into a mixed solvent containing phenol and tetrachloroethane at a ratio of 60:40 (mass ratio).

### {Measurement of Melt Viscosity}

Using a dehumidification dryer, the polyester resin sample was dried at 60° C. for 48 hours. Then, 20.0 g±5.0 g of each dried polyester resin was measured, and the melt viscosity thereof at a measurement temperature of 180° C. and shear rate of 6080 sec⁻¹ was measured with a melt viscosity measurement device. In cases where the resin temperature inside the furnace of the melt viscosity measurement device rose beyond the measurement temperature, the melt viscosity measurement was evaluated as “Fail”.

### {Glass Transition Temperature}

Using a differential scanning calorimeter (DSC-7 from PerkinElmer Co. Ltd.), the endothermic behavior of the polyester resin sample was observed in a nitrogen atmosphere while raising the temperature from 30° ° C. at a rate of 2° C./minute, and the midpoint temperature in the endothermic behavior due to glass transition was determined as the glass transition temperature (Tg).

{Occurrence of Clouding upon Molding}

Each polyester resin according to the respective Test Examples was molded at a molding temperature of 180° C. and a cooling temperature of 40° C. into a 9-mm-thick plate, to examine whether clouding occurred in the molded product. Note that the polyester resins of Test Examples 9 and 12, which could not be molded at 180° ° C., were molded at 220° C.
No: No clouding occurred in the molded product.
Yes: Clouding occurred in the molded product.

### {Content Resistance Test}

Assuming that the polyester resin is to be used as a container, a test was conducted as to whether the resin has resistance against contents to be contained. More specifically, a stress cracking test and a change-in-appearance test described below were conducted. The specimen used therein was a specimen obtained by molding the polyester resin into a plate shape 80 mm long, 10 mm wide, and 2 mm thick. Assuming that an external-use skin preparation is to be used as contents to be contained, commercially available sun-block cosmetics (cream and gel) and beauty essence (cream) were used as test agents to be applied to each specimen.

### {Stress Cracking Test}

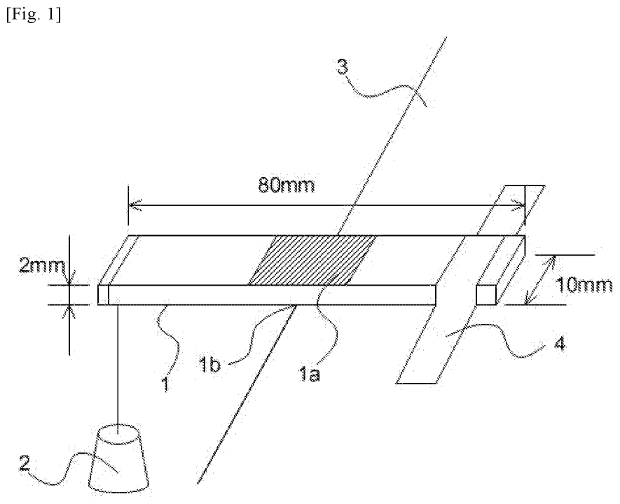

FIG. 1 illustrates a device used for the stress cracking test. A specimen 1 was mounted so as to protrude from a base 3 in a manner that the fulcrum 1b was located at approximately the midway area of the specimen in the longitudinal direction. One end of the specimen 1 was fixed to the base 3 with a fixing jig 4. A 200 g weight 2 was suspended from the other end of the specimen 1, such that a load of approximately 6.9 N·cm was applied to the fulcrum 1b. A test agent was applied on the upper surface of a region including the fulcrum 1b (application region 1a), and the sample was left to stand at 23° C. at a relative humidity of 50% RH for 24 hours. After 24 hours, the specimen 1 was examined to see if any cracks were formed. The evaluation criteria are as shown below.
A: No cracks were formed in the specimen.
B: Fine cracks were formed in the specimen.
C: Large cracks were formed in the specimen.
D: The specimen broke.

### {Change-in-Appearance Test}

A test agent was applied to one surface of the specimen. With the test agent applied thereto, the specimen was left to stand in an environment at 23° C. or 37° ° C., at a relative humidity of 50% RH for 7 days. After 7 days, the appearance of the specimen was examined.
A: There was no change in appearance of the specimen.
B: The specimen became slightly cloudy.
C: The specimen became cloudy, or the surface of the specimen became rough.

### {Measurement of Mechanical Properties}

The tensile elongation of each polyester resin was measured in conformity with ISO 527. The tensile elongation was measured for five samples, and the average value thereof was calculated. Also, the Charpy impact strength of each polyester resin was measured in conformity with ISO 179. The Charpy impact strength was measured for ten samples, and the average value thereof was calculated.

All of Test Examples 1 to 8 were able to obtain good ratings for all the evaluation items.

It was found that the containers produced in Test Examples 1 to 8 were usable as cosmetic containers.

In contrast, Test Examples 10 to 12, which contained 20 mol % or more of neopentyl glycol, were evaluated poorly in the stress cracking test. From this result, it is thought that the content by percentage of neopentyl glycol is preferably 18 mol % or less, more preferably 16 mol % or less, with respect to the total amount of the alcohol component.

In Test Example 12, which contained no isophthalic acid, the intrinsic viscosity was high, and the melt viscosity was so high that measurement was not possible. Also, clouding occurred at the time of molding the container. From these results, it is thought that the content by percentage of isophthalic acid is preferably 8 mol % or more with respect to the total amount of the acid component.

In Test Example 14, which contained 30 mol % of isophthalic acid, sufficient mechanical strength could not be obtained. From this result, it is thought that the content by percentage of isophthalic acid is preferably 28 mol % or less with respect to the total amount of the acid component.

Test Example 15, which contained 7 mol % of diethylene glycol, was evaluated poorly in the stress cracking test, and also evaluated poorly in the change-in-appearance test at 37° C. From these results, it is thought that the content by percentage of diethylene glycol is preferably 5 mol % or less with respect to the total amount of the alcohol component.

Test Example 13, in which the total content by percentage of isophthalic acid and neopentyl glycol was high, was evaluated poorly in the change-in-appearance test, and particularly in terms of content resistance at high temperature. From this result, it is thought that the total content by percentage is preferably 43 mol % or less.

In Test Example 9, in which the total content by percentage of isophthalic acid and neopentyl glycol was small, the melt viscosity was so high that measurement was not possible. Also, in Test Example 12, the molded product had poor transparency. From these results, it is thought that the total content by percentage is 24 mol % or more.

TABLE 1

| Test Example | | | | | | 1 | 2 | 3 | 4 | 5 | 6 | 7 | 8 |
|---|---|---|---|---|---|---|---|---|---|---|---|---|---|
| Compositional | | Acid | | (A1)TPA | | 75 | 75 | 75 | 77 | 75 | 88 | 88 | 75 |
| makeup | | component | | (A2)IPA | | 25 | 25 | 25 | 23 | 25 | 12 | 12 | 25 |
| (mol %) | | Alcohol | | (B1)EG | | 82 | 84 | 84 | 83 | 91 | 81 | 82 | 82 |
| | | component | | (B2)NPG | | 15 | 13 | 13 | 14 | 6 | 16 | 15 | 15 |
| | | | | (B3)DEG | | 3 | 3 | 3 | 3 | 3 | 3 | 3 | 3 |
| (A2) + (B2) | | | | | | 40 | 38 | 38 | 37 | 31 | 28 | 27 | 40 |
| Intrinsic viscosity (dl/g) | | | | | | 0.51 | 0.60 | 0.64 | 0.58 | 0.55 | 0.55 | 0.55 | 0.51 |
| Melt viscosity (Pa · s) | | | | | | 131 | 144 | 165 | 160 | 165 | 170 | 170 | 120 |
| Glass transition temperature | | | | | | 71 | 70 | 71 | 71 | 72 | 74 | 74 | 70 |
| (° C.) | | | | | | | | | | | | | |
| Transparency | | | Clouding upon | | | No | No | No | No | No | No | No | No |
| | | | molding | | | | | | | | | | |
| Content | Stress | | Sun block A | | | B | B | B | B | B | B | B | B |
| resistance | cracking | | Sun block B | | | B | B | B | B | B | B | B | B |
| | test | | Sun block C | | | B | B | B | B | B | B | B | B |
| | | | Sun block D | | | B | B | A | A | B | B | A | B |
| | | | Beauty cream A | | | A | A | A | A | A | B | A | A |
| | | | Beauty cream B | | | A | A | A | A | A | A | A | A |
| | Change-in- | | Sun | | 23° C. | A | A | A | A | A | A | A | A |
| | appearance | | block A | | | | | | | | | | |
| | test | | Sun | | 23° C. | A | A | A | A | A | A | A | A |
| | | | block B | | 37° C. | A | A | A | A | A | A | A | A |
| | | | Sun | | 23° C. | A | A | A | A | A | A | A | A |
| | | | block C | | 37° C. | A | B | B | A | A | A | A | A |
| | | | Sun | | 23° C. | A | A | A | A | A | A | A | A |
| | | | block D | | 37° C. | A | B | B | A | A | A | A | A |
| Mechanical | | Tensile elongation | | | | ≥200 | ≥200 | ≥200 | ≥200 | 180 | ≥200 | ≥200 | 180 |
| properties | | (%) | | | | | | | | | | | |
| | | Charpy impact | | | | 2.3 | 2.2 | 2.2 | 2.4 | 2.1 | 2.3 | 2.4 | 2.1 |
| | | strength (kJ/m²) | | | | | | | | | | | |

TABLE 2

| Test Example | | | | | | 9 | 10 | 11 | 12 | 13 | 14 | 15 |
|---|---|---|---|---|---|---|---|---|---|---|---|---|
| Compositional | | Acid | | (A1)TPA | | 88 | 85 | 80 | 100 | 70 | 70 | 76 |
| makeup | | component | | (A2)IPA | | 12 | 15 | 20 | 0 | 30 | 30 | 24 |
| (mol %) | | Alcohol | | (B1)EG | | 87 | 72 | 77 | 77 | 82 | 91 | 78 |
| | | component | | (B2)NPG | | 10 | 25 | 20 | 20 | 15 | 6 | 15 |
| | | | | (B3)DEG | | 3 | 3 | 3 | 3 | 3 | 3 | 7 |
| (A2) + (B2) | | | | | | 22 | 40 | 40 | 20 | 45 | 36 | 39 |
| Intrinsic viscosity (dl/g) | | | | | | 0.55 | 0.55 | 0.54 | 0.78 | 0.55 | 0.55 | 0.55 |
| Melt viscosity (Pa · s) | | | | | | Fail | 140 | 130 | Fail | 120 | 140 | 130 |
| Glass transition temperature | | | | | | 75 | 70 | 71 | 75 | 68 | 71 | 67 |
| (° C.) | | | | | | | | | | | | |
| Transparency | | | Clouding upon | | | No | No | No | Yes | No | No | No |
| | | | molding | | | | | | | | | |
| Content | Stress | | Sun block A | | | B | C | C | C | B | B | C |
| resistance | cracking | | Sun block B | | | B | C | C | C | B | B | C |
| | test | | Sun block C | | | B | C | C | B | B | B | C |
| | | | Sun block D | | | A | C | C | B | B | B | C |
| | | | Beauty cream A | | | A | B | B | A | B | A | B |
| | | | Beauty cream B | | | A | B | A | A | A | A | B |
| | Change-in- | | Sun | | 23° C. | A | B | B | B | C | A | B |
| | appearance | | block A | | | | | | | | | |
| | test | | Sun | | 23° C. | A | A | A | A | A | A | A |
| | | | block B | | 37° C. | A | A | A | A | A | A | A |
| | | | Sun | | 23° C. | A | A | A | A | B | A | A |
| | | | block C | | 37° C. | A | B | B | B | C | A | C |
| | | | Sun | | 23° C. | A | A | A | A | A | A | A |
| | | | block D | | 37° C. | A | A | B | A | C | A | C |
| Mechanical | | Tensile elongation | | | | ≥200 | 180 | 179 | ≥200 | 150 | 80 | ≥200 |
| properties | | (%) | | | | | | | | | | |
| | | Charpy impact | | | | 2.3 | 2.1 | 2.1 | 2.3 | 2.0 | 1.8 | 2.3 |
| | | strength (kJ/m²)) | | | | | | | | | | |

The polyester resins (including molded products), as well as methods for producing the same and for using the same, cosmetic containers and cosmetic products according to the present invention have been described according to the foregoing embodiments and examples, but the invention is not limited to the foregoing embodiments and examples and may encompass various transformations, modifications, and improvements made to the various disclosed elements (including elements disclosed in the Claims, Description, and Drawings) within the scope of the invention and according to the fundamental technical idea of the present invention. Further, various combinations, substitutions, and selections of the various disclosed elements are possible within the scope of the claims of the invention.

Further issues, objectives, and embodiments (including modifications) of the present invention are revealed also from the entire disclosure of the invention including the Claims.

The numerical ranges disclosed herein are to be construed in such a manner that arbitrary numerical values and ranges falling within the disclosed ranges are treated as being concretely described herein, even where not specifically stated.

### INDUSTRIAL APPLICABILITY

The polyester resin of the present disclosure has excellent moldability and mechanical properties. Therefore, the polyester resin of the present disclosure and molded products thereof can be used for a wide variety of molding materials, for example, for containers, electric/electronic components, automotive materials, etc.

### REFERENCE SIGNS LIST

1: Specimen
1a: Application region
1b: Fulcrum
2: Weight
3: Base
4: Fixing jig

1. A polyester resin comprising a polymer of an acid component (A) and an alcohol component (B), wherein:
the component (A) contains 72 mol % or more of a terephthalic acid component (A1) and from 8 to 28 mol % of an isophthalic acid component (A2) with respect to a total amount of the component (A);
the component (B) contains 77 mol % or more of an ethylene glycol component (B1) and from 4 to 18 mol % of a 2,2-dimethyl-1,3-propanediol component (B2) with respect to a total amount of the component (B);
a sum of a content by percentage of the component (A2) with respect to the component (A) and a content by percentage of the component (B2) with respect to the component (B) is from 24 to 43 mol %;
a content of a diethylene glycol component (B3) with respect to the total amount of the component (B) is 5 mol % or less; and
the polyester resin has an intrinsic viscosity of from 0.48 to 0.67 dl/g.

2. The polyester resin according to claim 1, wherein said sum is from 27 to 40 mol %.

3. The polyester resin according to claim 1, wherein the polyester resin has a melt viscosity of from 100 to 200 Pas at 180° C.

4. The polyester resin according to claim 1, wherein the polyester resin has a tensile elongation of 100% or greater.

5. The polyester resin according to claim 1, wherein the polyester resin has a Charpy impact strength of 2 KJ/m² or greater.

6. The polyester resin according to claim 1, wherein the polyester resin has a container shape.

7. A cosmetic container comprising the polyester resin according to claim 1.

8. A cosmetic product comprising:
a cosmetic; and
the cosmetic container according to claim 7, containing the cosmetic.

9. A method for using the polyester resin according to claim 1, comprising using the polyester resin for a cosmetic container.

10. The polyester resin according to claim 2, wherein the polyester resin has a melt viscosity of from 100 to 200 Pas at 180° C.

11. The polyester resin according to claim 2, wherein the polyester resin has a tensile elongation of 100% or greater.

12. The polyester resin according to claim 3, wherein the polyester resin has a tensile elongation of 100% or greater.

13. The polyester resin according to claim 10, wherein the polyester resin has a tensile elongation of 100% or greater.

14. The polyester resin according to claim 2, wherein the polyester resin has a Charpy impact strength of 2 KJ/m² or greater.

15. The polyester resin according to claim 3, wherein the polyester resin has a Charpy impact strength of 2 KJ/m² or greater.

16. The polyester resin according to claim 4, wherein the polyester resin has a Charpy impact strength of 2 KJ/m² or greater.

17. The polyester resin according to claim 10, wherein the polyester resin has a Charpy impact strength of 2 KJ/m² or greater.

18. The polyester resin according to claim 11, wherein the polyester resin has a Charpy impact strength of 2 KJ/m² or greater.

19. The polyester resin according to claim 12, wherein the polyester resin has a Charpy impact strength of 2 KJ/m² or greater.

20. The polyester resin according to claim 13, wherein the polyester resin has a Charpy impact strength of 2 KJ/m² or greater.
